(19) United States
(12) Patent Application Publication
(10) Pub. No.: US 2016/0375462 A1
(43) Pub. Date: Dec. 29, 2016

(54) SUBSTRATE PROCESSING APPARATUS, SUBSTRATE PROCESSING METHOD, AND RECORDING MEDIUM

(71) Applicant: Tokyo Electron Limited, Tokyo (JP)

(72) Inventor: Satoshi Kaneko, Koshi City (JP)

(21) Appl. No.: 15/187,965

(22) Filed: Jun. 21, 2016

(30) Foreign Application Priority Data
Jun. 23, 2015 (JP) 2015-125695

(51) Int. Cl. B05D 1/02; B05B 13/02

(52) U.S. Cl. CPC B05D 1/02; B05B 13/02

(57) ABSTRACT

A scratch on a substrate held by a wafer holding unit or adhesion of an impurity to the substrate can be suppressed. A substrate processing apparatus 1 includes a wafer holding unit 22 configured to be rotated and a nozzle 50 configured to supply a coating liquid 50a. The wafer holding unit 22 includes a holding surface 23 and an opening 24. The coating liquid 50a is supplied onto a peripheral portion of the holding surface 23 from the nozzle 50, and then, the coating liquid is dried, so that an annular coating film 25, on which a wafer W is placed, is formed on the holding surface 23.

### CROSS-REFERENCE TO RELATED APPLICATION

This application claims the benefit of Japanese Patent Application No. 2015-125695 filed on Jun. 23, 2015, the entire disclosures of which are incorporated herein by reference.

### TECHNICAL FIELD

The embodiments described herein pertain generally to a substrate processing apparatus and a substrate processing method of performing a process such as a developing process on a substrate with a fluid, and a recording medium therefor.

### BACKGROUND

A mask for forming a preset pattern on a surface of a semiconductor wafer (hereinafter, simply referred to as “wafer”) or a glass substrate for a liquid crystal display (LCD substrate) is obtained through a series of processes of coating a resist on a surface of a substrate such as a wafer, irradiating light, an electronic beam or an ion beam to a surface of the resist, and performing a liquid process with a developing solution (processing liquid).

Conventionally, such a liquid process is performed as follows. A substrate such as a wafer is attracted to and held on a substrate holding device configured to, for example, vacuum-attract the substrate. Then, by rotating the wafer while supplying a processing liquid onto a surface of the wafer from a supply nozzle, the liquid process is performed.

When holding the substrate such as the wafer on the substrate holding device during the liquid process, however, if there exists a scratch or a particle on a holding surface of the substrate holding device, the substrate may also be scratched or an impurity may adhere to the substrate due to the scratch or the particle on the holding surface.

Furthermore, in case that the hardness of the holding surface of the substrate holding device is high, there is also a concern that the substrate may be scratched by the holding surface.

### SUMMARY

In view of the foregoing, exemplary embodiments provide a substrate processing apparatus and a substrate processing method of suppressing a scratch on a substrate held by a substrate holding device or adhesion of an impurity to the substrate, and a recording medium therefor.

In one exemplary embodiment, a substrate processing apparatus includes a substrate holding device including a holding surface and a suction portion provided at the holding surface; and a coating liquid supplying device configured to supply a coating liquid such that the coating liquid surrounds the suction portion provided at the holding surface of the substrate holding device and configured to form an annular coating film, on which a substrate is placed, on the holding surface.

In another exemplary embodiment, a substrate processing method includes preparing a substrate holding device including a holding surface and a suction portion provided at the holding surface; forming an annular coating film, on which a substrate is placed, on the holding surface by supplying a coating liquid from a coating liquid supplying device such that the coating liquid surrounds the suction portion provided at the holding surface of the substrate holding device; and placing the substrate on the annular coating film on the holding surface, and attracting and holding the substrate by the suction portion.

In still another exemplary embodiment, there is provided a computer-readable recording medium having stored thereon computer executable instructions that, in response to execution, cause a computer to perform a substrate processing method. Here, the substrate processing method includes preparing a substrate holding device including a holding surface and a suction portion provided at the holding surface; forming an annular coating film, on which a substrate is placed, on the holding surface by supplying a coating liquid from a coating liquid supplying device such that the coating liquid surrounds the suction portion provided at the holding surface of the substrate holding device; and placing the substrate on the annular coating film on the holding surface, and attracting and holding the substrate by the suction portion.

According to the exemplary embodiments, it is possible to suppress the scratch on the substrate held by the substrate holding device or the adhesion of the impurity to the substrate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a cross sectional view illustrating an example of a substrate processing apparatus according to an exemplary embodiment;

FIG. 2A is a perspective view illustrating a nozzle configured to supply a processing fluid, and FIG. 2B is a plan view illustrating the nozzle;

FIG. 3A to FIG. 3F are diagrams for describing a substrate processing method according to the exemplary embodiment;

FIG. 4 is a bottom view illustrating a substrate holding device of the substrate processing apparatus; and

FIG. 5 is a plan view illustrating a holding surface of the substrate holding device and a coating liquid supplying device.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current exemplary embodiment. Still, the exemplary embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

### Exemplary Embodiment

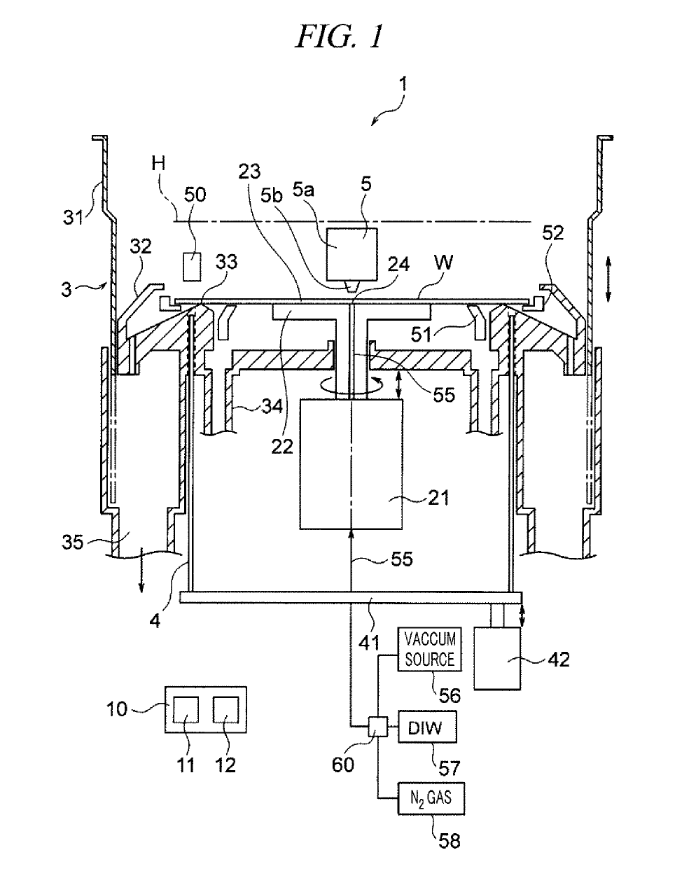

Hereinafter, exemplary embodiments will be described with reference to FIG. 1 to FIG. 4, which form a part of the description.

Here, FIG. 1 is a longitudinal cross sectional view illustrating a substrate processing apparatus according to an exemplary embodiment. As depicted in FIG. 1, the substrate processing apparatus 1 includes a wafer holding unit (substrate holding device) 22 and a nozzle (processing fluid supplying device) 5. The wafer holding unit 22 is configured to attract and hold a central portion of a wafer W as a substrate. Further, the wafer holding unit 22 is configured to hold the wafer W horizontally with a processing target surface of the wafer W facing upwards. The wafer holding unit 22 is also configured to rotate the wafer W around a vertical axis and, also, to move the wafer W up and down. The wafer holding unit 22 is made of a metal or a resin such as, but not limited to, polytetrafluoroethylene or polyetheretherketone. The nozzle 5 is disposed above the wafer holding unit 22 and is configured to supply a processing liquid such as a chemical liquid or DIW (DeIonized Water) or supply a drying gas such as a N₂ gas onto a surface of the wafer W held by the wafer holding unit 22. Here, the wafer holding unit 22 is configured as the substrate holding device, and includes a holding surface 23 for holding thereon the wafer W; and an opening (suction portion) opened at a central portion of the holding surface 23 and configured to vacuum-attract the wafer W. The wafer holding unit 22 is configured to be rotated around the vertical axis on a rotational shaft and moved up and down by a driving unit 21 composed of a combination of an elevating device and a motor. In this configuration, the wafer W is held by the wafer holding unit 22 such that it is rotatable and vertically movable between a wafer processing position where the wafer W is held by the wafer holding unit 22 and a wafer transfer position H above the wafer processing position, shown in FIG. 1.

Provided around the wafer holding unit 22 is a cylindrical recovery cup 3 configured to suppress the processing liquid from being dispersed around when the processing liquid supplied onto the wafer is scattered out. The recovery cup 3 is provided to surround the wafer W placed at the wafer processing position. The recovery cup 3 includes an outer cup 31 and an inner cup 32. The outer cup 31 is configured to be movable up and down by a non-illustrated elevating device such that an upper end of the outer cup 31 is located above the wafer transfer position H while suppressing the dispersion of the processing liquid, whereas the upper end of the outer cup 31 is located below the wafer transfer position H while transferring the wafer W or supplying the processing liquid.

Within the outer cup 31, the inner cup 32 is provided at a position below the wafer transfer position H such that an upper end thereof is located above the wafer W when the wafer W is located at the wafer processing position. At an outer side of the wafer W, the inner cup 32 is inwardly and upwardly inclined. Further, to suppress the processing liquid from being introduced to a rear surface of the wafer W, the inner cup 32 is provided with, under the wafer W, an annular protrusion 33 which is protruded just to the extent that it is not in contact with a periphery of the rear surface of the wafer W which is located at the wafer processing position. The inner cup 32 is inclined upwards from an outside of the wafer W toward the protrusion 33.

Further, a multiple number of, e.g., three holding pins 4 are provided at positions of the inner cup 32 corresponding to a peripheral region of the rear surface of the wafer W. The holding pins 4 are configured to maintain the wafer W lifted from the wafer holding unit 22. Each holding pin 4 is made of, by way of example, but not limitation, stainless steel, and a protective member made of, by way of non-limiting example, alumina is provided at a leading end of each holding pin 4. A contact area between the holding pins 4 and the wafer W when holding the wafer W with the holding pins 4 is set to be much smaller than a contact area between the wafer W and the holding surface 23 of the wafer holding unit 22 when the wafer W is held on the holding surface 23.

Lower ends of these holding pins 4 are connected to an elevating device 42 via a horizontal supporting arm 41. Upper ends of the holding pins 4 are allowed to be moved up and down between a standby position which is under the wafer W placed at the wafer processing position, and a raised position which is above the standby position and where the wafer W is lifted up from the wafer holding unit 22 by the holding pins 4. Further, the recovery cup 3 is connected with a liquid drain path 34 for the processing liquid and a discharge path 35 serving as both a gas exhaust path and a liquid drain path. The discharge path 35 is connected to a non-illustrated gas-liquid separator.

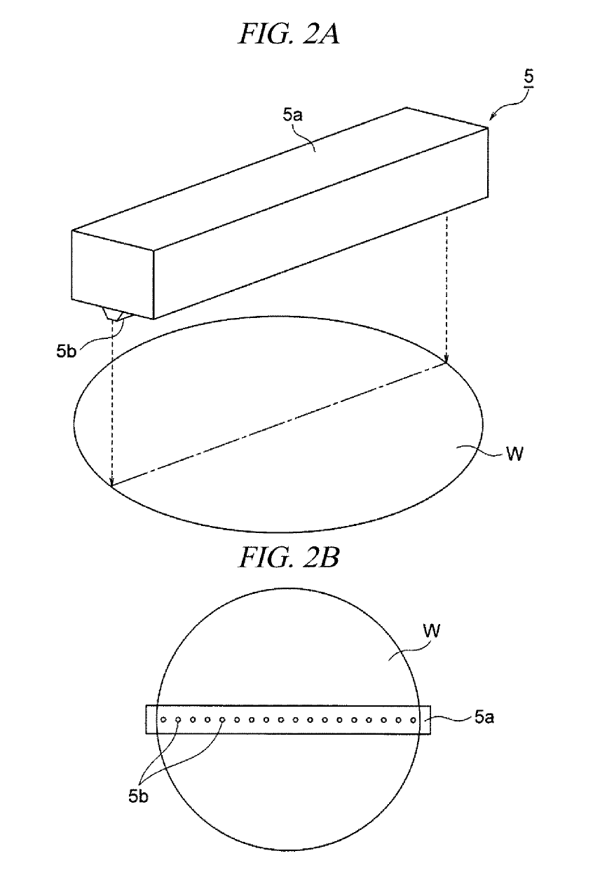

As mentioned above, the nozzle 5 which forms a supplying unit configured to supply a processing fluid onto the surface of the wafer W is provided above the wafer W which is placed at the wafer processing position while being vacuum-attracted to the wafer holding unit 22. The nozzle 5 includes, as depicted in FIG. 2A and FIG. 2B, a nozzle main body 5a having a narrow rod shape elongated sideways; and discharge holes 5b provided at a bottom surface of the nozzle main body 5a to discharge the processing fluid toward the surface of the wafer W in a diametric direction thereof. The nozzle main body 5a and the discharge holes 5b are configured to supply the processing fluid to the vicinity of a center line (a line passing through a center of the wafer W and extended in the diametric direction) on the surface of the wafer W.

Further, as shown in FIG. 1, a nozzle (coating liquid supplying device) 50 is provided above the wafer holding unit 22. The nozzle 50 is configured to form, on the holding surface 23, an annular coating film 25 having a required film thickness to surround the opening 24 by supplying a coating liquid 50a onto, for example, a peripheral portion of the holding surface 23 of the wafer holding unit 22. Here, the annular shape of the coating film 25 means a closed strip shape, and is not limited to a circular shape.

Here, the nozzle 50 is configured to supply the coating liquid such as a top coating liquid, a resist liquid or an antireflection coating liquid onto the holding surface 23 of the wafer holding unit 22 while the wafer holding unit 22 is being rotated. The coating liquid contains a solvent; and a water-soluble remnant made of a resin or the like. The coating liquid supplied on the holding surface 23 is coated on a peripheral portion of the holding surface 23 in a ring shape as the wafer holding unit 22 is rotated. The solvent in the coating liquid on the holding surface 23 is scattered out and is guided into a coating liquid recovery cup 51, whereas the remnant remains on the peripheral portion of the holding surface 23, so that an annular coating film 25 is formed thereon. Desirably, the annular coating film 25 contains an antistatic agent, so that static electricity is not charged in the annular coating film 25. Further, in case that the solvent contained in the coating liquid 50a has high volatility and is hardly scattered out when the wafer holding unit 22 is rotated, the annular coating film 25 need not be formed at the peripheral portion of the holding surface 23, and the annular coating film 25 may be formed at any position surrounding the opening 24 as long as the wafer W can be still held thereon. In such a case, the coating liquid recovery cup 51 need not be provided.

The coating liquid recovery cup 51 is provided between the wafer holding unit 22 and the holding pins 4, and is configured to collect the coating liquid supplied onto the holding surface 23 from the nozzle 50 and guide the collected coating liquid downwards. The coating liquid recovery cup 51 is also configured to be vertically moved.

Further, a ring guide 52 configured to hold and lift up a peripheral portion of the wafer W placed on the wafer holding unit 22 is provided around the wafer holding unit 22.

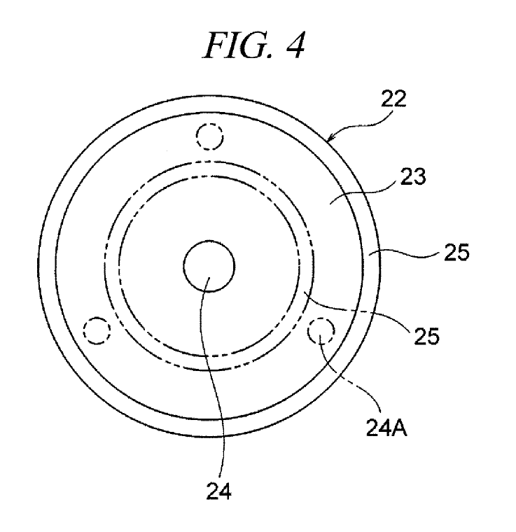

The holding surface 23 of the wafer holding unit 22 is provided with the opening 24 as mentioned above. The opening 24 is formed at a central portion of the holding surface 23, and the aforementioned annular coating film 25 is formed at the peripheral portion of the holding surface 23 (see FIG. 4).

The opening 24 formed at the holding surface 23 is connected to a vacuum source 56 via a communication line 55 extended through the wafer holding unit 22.

In addition to the vacuum source 56, a DIW supply source 57 and a N₂ gas supply source 58 are also connected to the communication line 55. Specifically, the communication line 55 can be selectively connected to the vacuum source 56, the DIW supply source 57 or the N₂ gas supply source 58 via a switching device 60.

In this configuration, by connecting the communication line 55 to the vacuum source 56, the opening 24 has the attracting (suctioning) function. Further, by connecting the communication line 55 to the DIW supply source 57, DIW from the DIW supply source 57 via the communication line 55 can be supplied through the opening 24. Furthermore, by connecting the communication line 55 to the N₂ gas supply source 58, a N₂ gas from the N₂ gas supply source 58 via the communication line 55 can be supplied through the opening 24.

Individual components of the substrate processing apparatus 1 having the above-described configuration, for example, the driving unit 21 of the wafer holding unit 22, the nozzle 5, the nozzle 50, the elevating device 42, the switching device 60 and so forth are connected with a controller 10 as illustrated in FIG. 1. The controller 10 is implemented by a computer including a CPU 11 and a recording medium 12. The recording medium 12 stores thereon programs including step (command) sets for the control of operations of the substrate processing apparatus 1, i.e., operations according to a liquid processing method. These programs may be stored on the recording medium 12 implemented by, by way of non-limiting example, a hard disk, a compact disk, a magnetic optical disk, a memory card, or the like and may be installed in the computer therefrom.

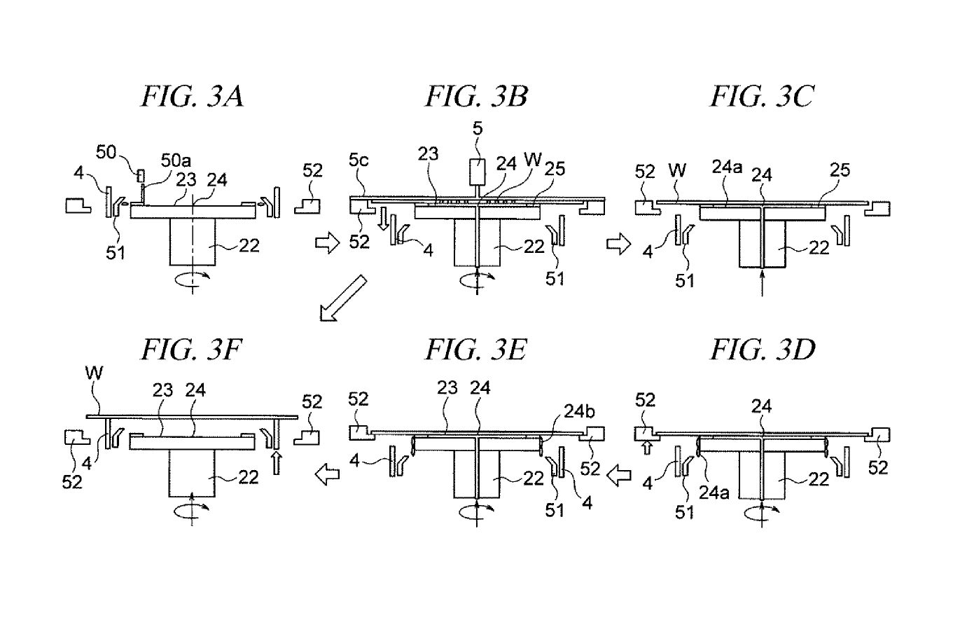

Now, referring to FIG. 3A to FIG. 3F, an operation of the exemplary embodiment having the above-described configuration will be explained.

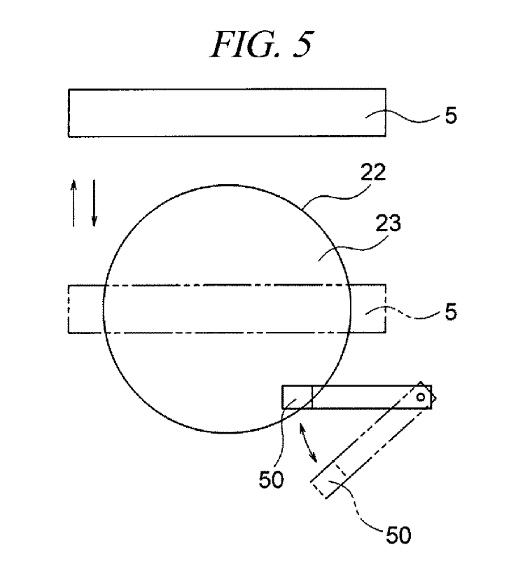

First, as depicted in FIG. 5, the nozzle (coating liquid supplying device) 50 is moved from a retreat position to a position above, e.g., a peripheral portion of the holding surface 23. While, rotating the wafer holding unit 22, the coating liquid 50a is supplied onto the peripheral portion of the holding surface 23 of the wafer holding unit 22 from the nozzle (coating liquid supplying device) 50.

In this case, as the wafer holding unit 22 is rotated, the coating liquid 50a is diffused onto the peripheral portion of the holding surface 23 in a ring shape, and the coating liquid 50a scattered out from the peripheral portion of the holding surface 23 is guided downwards from the peripheral portion of the holding surface 23 by the coating liquid recovery cup 51. As such, since the coating liquid 50a is guided downwards from the peripheral portion of the holding surface 23 by the coating liquid recovery cup 51, the coating liquid 50a is suppressed from being dispersed to the recovery cup 3 provided at the outside of the wafer holding unit 22.

The coating liquid 50a supplied from the nozzle 50 is, as stated above, the top coating liquid, the resist liquid, the antireflection coating liquid, or the like, and is diffused onto the peripheral portion of the holding surface 23 in the ring shape.

Then, the solvent in the coating liquid 50a on the holding surface 23 is scattered out, and the remnant of the coating liquid 50a remains to be hardened, so that the annular coating film 25 is formed at the peripheral portion of the holding surface 23 (see FIG. 3A and FIG. 4). After the annular coating film 25 having a required film thickness is formed, the supply of the coating liquid 50a from the nozzle 50 is stopped. Then, the nozzle 50 is moved to the retreat position, and the rotation of the wafer holding unit 22 is stopped.

The annular coating film 25 formed on the peripheral portion of the holding surface 23 is made of a softer material, as compared to the holding surface 23 of the wafer holding unit 22. Thus, the wafer W can be placed on the annular coating film 25 without being scratched.

Subsequently, as depicted in FIG. 1, FIG. 3A and FIG. 3B, the outer cup 31 is lowered to a position lower than the wafer transfer position. Then, the wafer W is moved to the wafer transfer position above the wafer holding unit 22 by a non-illustrated transfer arm, and then, transferred onto the holding pins 4 located at the raised position. Then, the holding pins 4 are lowered, and the wafer W is attracted to and held on the wafer holding unit 22. At this time, the communication line 55 is connected to the vacuum source 56.

Thereafter, the nozzle (processing fluid supplying device) 5 located at the standby position is moved to a position above the wafer holding unit 22. At this time, the upper end of the inner cup 32 is located above the wafer W. A processing liquid 5c such as, but not limited to, a developing liquid or a cleaning liquid is supplied from the nozzle 5 to the vicinity of the center line of the wafer W, and the wafer holding unit 22 is rotated.

By supplying the processing liquid 5c onto the wafer W from the nozzle 5 as stated above, the liquid process can be performed on the wafer W.

In the meantime, the ring guide 52 is located around the wafer W without being in contact with the wafer W, and the processing liquid 5c supplied from the nozzle 5 onto the wafer W is guided into the inner cup 32 via a top surface of the ring guide 52.

The annular coating film 25 is made of a softer material, as compared to the holding surface 23 of the wafer holding unit 22. Further, the annular coating film 25 is upwardly protruded from the holding surface 23. Thus, as compared to the case where the wafer W is directly placed on the holding surface 23, the scratch on the wafer W or the adhesion of the impurity to the wafer W, which might be caused by the scratch or the particle that exists on the holding surface 23, may be suppressed.

Therefore, it is possible to perform the liquid process on the wafer W while maintaining the wafer W clean.

Subsequently, as illustrated in FIG. 3C, the rotation of the wafer holding unit 22 is stopped. Further, the supply of the processing liquid 5c from the nozzle 5 is stopped, and the nozzle 5 is moved to the retreat position. Further, the communication line 55 is connected to the DIW supply source 57 by the switching device 60. Then, the DIW 24a is supplied to the opening 24 of the holding surface 23 from the DIW supply source 57 through the communication line 55, and the DIW 24a is then discharged toward a rear surface of the wafer W from the opening 24. At this time, the wafer W is not attracted through the opening 24 but is just placed on the annular coating film 25 of the holding surface 23.

Therefore, the DIW 24a discharged from the opening 24 is flown outwards along the rear surface of the wafer W.

Here, the annular coating film 25 formed on the holding surface 23 is made of the water-soluble material. Accordingly, the annular coating film 25 is easily dissolved or etched by the DIW (coating film processing liquid) 24a discharged from the opening 24, and the annular coating film 25 dissolved or etched by the DIW 24a is scattered out with the DIW 24a through a gap between the holding surface 23 and the rear surface of the wafer W. At this time, the ring guide 52 may be located around the edge of the wafer W while being slightly spaced apart from the wafer W. Alternatively, the ring guide 52 may be raised while holding the wafer W thereon, so that the wafer W and the holding surface 23 are not in contact with each other. In this way, the annular coating film 25 on the holding surface 23 is removed. In this case, the opening 24 of the holding surface 23 serves as a coating film processing liquid supplying portion.

Thereafter, as shown in FIG. 3D, if the wafer W is not held by the ring guide 52, the ring guide 52 is lifted up, and the wafer W is held by the ring guide 52 while being slightly spaced apart from the holding surface 23. In this state, the wafer holding unit 22 is rotated. The DIW 24a is continuously charged from the opening 24 of the holding surface 23 toward the rear surface of the wafer W being rotated. The DIW 24a discharged from the opening 24 is flown outwards through the gap between the holding surface 23 and the rear surface of the wafer W after cleaning the rear surface of the wafer W being rotated and the holding surface 23. In this way, the holding surface 23 and the rear surface of the wafer W are cleaned.

Afterwards, as depicted in FIG. 3E, the wafer holding unit 22 is continuously rotated, and the communication line 55 is connected to the N₂ gas supply source 58 by the switching device 60. In this case, the discharge of the DIW 24a from the opening 24 is stopped, and, instead, the N₂ gas 24b supplied from the N₂ gas supply source 58 via the communication line 55 is discharged from the opening 24 toward the rear surface of the wafer W.

The N₂ gas 24b discharged toward the rear surface of the wafer W pushes out the DIW 24a remaining on the holding surface 23 and the rear surface of the wafer W, so that the holding surface 23 and the rear surface of the wafer W are dried. In this case, the opening 24 serves as a N₂ gas supply unit.

Thereafter, as shown in FIG. 3F, the holding pins 4 are raised to lift the wafer W up to the wafer transfer position above, and, then, the ring guide 52 is lowered. Then, the wafer W is carried out of the apparatus by the non-illustrated transfer arm. At this time, the outer cup 31 is lowered in advance, and the upper end of the outer cup 31 is located below the wafer transfer position.

According to the present exemplary embodiment as described above, the annular coating film 25 having a required film thickness and made of a material softer than the holding surface 23 can be formed on the holding surface 23 of the wafer holding unit 22, and the wafer W can be placed on this annular coating film 25. Accordingly, as compared to the case where the wafer W is directly placed on the holding surface 23, it is possible to suppress the scratch on the wafer W or the adhesion of the impurity to the wafer W, which might be caused by the scratch or the particle that exists on the holding surface 23. Further, since the annular coating film 25 formed on the holding surface 23 is made of a water-soluble material, the annular coating film 25 can be easily removed from the holding surface 23 by being dissolved in or etched by the DIW 24a after performing the liquid process on the wafer W placed on the annular coating film 25 on the holding surface 23. Furthermore, whenever a new wafer W is placed on the holding surface 23 of the wafer holding unit 22, a new annular coating film 25 can be formed easily and simply.

### Modification Example of Exemplary Embodiment

Now, a modification example of the exemplary embodiment will be described. The above exemplary embodiment has been described for the example where the annular coating film 25 formed on the holding surface 23 is removed by being dissolved or etched by the DIW 24a supplied to the holding surface 23 from the opening 24 formed at the central portion of the holding surface 23. However, the exemplary embodiment is not limited to the mentioned example, and three openings 24A for supplying the DIW may be additionally formed at peripheral portions of the holding surface 23 (see FIG. 4). In this case, the opening 24 at the central portion of the holding surface 23 is connected to the vacuum source 56 and serves as the suctioning unit. Further, the openings 24A at the peripheral portions are connected to the DIW supply source 57 or the N₂ gas supply source 58 selectively to serve as the DIW supplying unit or the N₂ gas supplying unit.

Alternatively, the DIW supplying unit configured to supply the DIW for dissolving or etching the annular coating film 25 may be provided above the wafer holding unit 22.

Furthermore, in the above-described exemplary embodiment, after the liquid process is performed on the wafer W which is attracted to and held on the annular coating film 25 formed on the holding surface 23 (FIG. 3B), the annular coating film 25 is removed by being dissolved or etched by the DIW 24a (FIG. 3C). However, the exemplary embodiment is not limited thereto. That is, after the liquid process is performed on the wafer W placed on the annular coating film 25 (FIG. 3B), the annular coating film 25 may not be removed, and the wafer W on the annular coating film 25 may be raised up to the wafer transfer position by the holding pins 4 and taken out of the apparatus by the transfer arm (FIG. 3F). In this case, the annular coating film 25 can be used continually over multiple times of liquid processes.

Further, in the above-described exemplary embodiment, the coating liquid is supplied from the nozzle 5, and the processing fluid is supplied from the nozzle 50 which is separately provided from the nozzle 5. However, the exemplary embodiment may not be limited thereto, and both the coating liquid and the processing fluid may be supplied from either one of the nozzle 5 and the nozzle 50.

In addition, the annular coating film 25 may not be limited to being formed on the flat holding surface 23. By way of example, the annular coating film 25 may be formed on a top portion of an annular protrusion of the holding surface 23 (not shown), or the annular coating film 25 may be formed to be protruded from an annular recess of the holding surface 23 (not shown).

Moreover, in the above-described exemplary embodiment, the annular coating film 25 is formed on the wafer holding unit configured to attract/hold and rotate the wafer W. However, the exemplary embodiment is not limited thereto, and the annular coating film 25 may be formed on a wafer holding unit configured to attract and hold the wafer W without rotating the wafer W.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting.

We claim:

1. A substrate processing apparatus, comprising:
a substrate holding device including a holding surface and a suction portion provided at the holding surface; and
a coating liquid supplying device configured to supply a coating liquid such that the coating liquid surrounds the suction portion provided at the holding surface of the substrate holding device and configured to form an annular coating film, on which a substrate is placed, on the holding surface.

2. The substrate processing apparatus of claim 1,
wherein the substrate holding device is configured to be rotated.

3. The substrate processing apparatus of claim 1, further comprising:
a coating film processing liquid supplying portion configured to supply a processing liquid for dissolving or etching the annular coating film on the holding surface.

4. The substrate processing apparatus of claim 1,
wherein holding pins each configured to lift up the substrate held on the substrate holding device are provided around the substrate holding device.

5. The substrate processing apparatus of claim 1,
wherein a ring guide configured to hold and lift up a peripheral portion of the substrate held on the substrate holding device is provided around the substrate holding device.

6. The substrate processing apparatus of claim 4,
wherein a coating liquid recovery cup configured to downwardly guide the coating liquid supplied onto a peripheral portion of the holding surface of the substrate holding device is provided between the substrate holding device and the holding pins.

7. The substrate processing apparatus of claim 1,
wherein a processing fluid supplying device configured to supply a processing fluid onto the substrate held on the substrate holding device is provided above the substrate holding device.

8. A substrate processing method, comprising:
preparing a substrate holding device including a holding surface and a suction portion provided at the holding surface;
forming an annular coating film, on which a substrate is placed, on the holding surface by supplying a coating liquid from a coating liquid supplying device such that the coating liquid surrounds the suction portion provided at the holding surface of the substrate holding device; and
placing the substrate on the annular coating film on the holding surface, and attracting and holding the substrate by the suction portion.

9. The substrate processing method of claim 8,
wherein the substrate holding device is configured to be rotated.

10. The substrate processing method of claim 8, further comprising:
supplying a processing fluid onto the substrate held by the substrate holding device from a processing fluid supplying device provided above the substrate holding device.

11. The substrate processing method of claim 8,
wherein, in supplying the coating liquid onto a peripheral portion of the holding surface, the coating liquid is guided downwards by a coating liquid recovery cup provided around the substrate holding device.

12. The substrate processing method of claim 8,
wherein a processing liquid for dissolving or etching the annular coating film on the holding surface is supplied from a coating film processing liquid supplying portion.

13. The substrate processing method of claim 12,
wherein a peripheral portion of the substrate held on the substrate holding device is held and lifted up by a ring guide provided around the substrate holding device.

14. The substrate processing method of claim 8,
wherein the coating liquid contains a solvent and a remnant, and
after the coating liquid is supplied on the holding surface, the solvent is scattered out and the remnant remains on the holding surface.

15. The substrate processing method of claim 14,
wherein the coating liquid contains any one of a top coating liquid, a resist liquid and an antireflection coating liquid.

16. A computer-readable recording medium having stored thereon computer executable instructions that, in response to execution, cause a computer to perform a substrate processing method,
wherein the substrate processing method comprises:
preparing a substrate holding device including a holding surface and a suction portion provided at the holding surface;
forming an annular coating film, on which a substrate is placed, on the holding surface by supplying a coating liquid from a coating liquid supplying device such that the coating liquid surrounds the suction portion provided at the holding surface of the substrate holding device; and
placing the substrate on the annular coating film on the holding surface, and attracting and holding the substrate by the suction portion.
